(19) United States
(12) Patent Application Publication
(10) Pub. No.: US 2005/0240820 A1
(43) Pub. Date: Oct. 27, 2005

(54) Method and apparatus for multiprocessor debug support

(76) Inventors: Eric F. Vannerson, Phoenix, AZ (US); Kalpesh D. Mehta, Chandler, AZ (US); Ernest P. Chen, Gilbert, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/815,904

(22) Filed: Mar. 31, 2004

(51) Int. Cl. G06F 11/00

(52) U.S. Cl. 714/35

(57) ABSTRACT

A device having at least one processor connected a controller and a memory; where the controller to execute a debug process. The debug process attaches a breakpoint bit field to each instruction. A system having image signal processors (ISPs), each ISP including processor elements (PEs). The ISPs include a debug instruction register connected to a first mux element. An instruction memory is connected to an instruction register. A decoder is connected to the instruction register. An execution unit is connected to the decoder. A debug executive unit is connected to the instruction memory, and a second mux element is connected to the execution unit and local registers. The decoder decodes a breakpoint bit field of each instruction.

### BACKGROUND

1. Field

The embodiments relate to debugging, co-development and co-validation of software, and more particularly to real-time debugging, co-development and co-validation of software within a multiprocessor environment.

2. Description of the Related Art

With processing systems today one commonly used approach for implementing hardware debugging features is known as scan-based debugging. In scan-based debugging an internal state is scanned in/out to obtain controllability and visibility into the system. Typically, scan-based debugging is used in silicon implementations. One of the problems with scan-based debugging is that it generally requires infrastructure support. Another problem with scan-based debugging is the speed of debugging, i.e. system delay caused by debugging.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 illustrates a multi-microprocessor chip.

FIG. 2 illustrates a plurality of processing elements (PEs).

FIG. 3 illustrates a co-development environment for an embodiment.

FIG. 4 illustrates an embodiment including a processing chip and a debug process.

FIG. 5 illustrates an embodiment where an instruction includes an additional bit field added.

FIG. 6 illustrates a control status register including three additional bit fields added.

FIG. 7A illustrates an embodiment of a system having a debug process.

FIG. 7B illustrates the embodiment illustrated in FIG. 7A showing debug hardware.

FIG. 8A illustrates an embodiment of a process for debugging a multi-microprocessor architecture environment.

FIG. 8B illustrates a process for reading and writing registers.

FIG. 8C illustrates a process for setting/clearing the run bit, the single-step bit and debug bit fields.

FIG. 8D illustrates a process for setting breakpoints for instructions, reading/writing the breakpoint bit field, and reading/writing instructions.

### DETAILED DESCRIPTION

The embodiments discussed herein generally relate to a method and apparatus for debugging a multiprocessor environment. Referring to the figures, exemplary embodiments will now be described. The exemplary embodiments are provided to illustrate the embodiments and should not be construed as limiting the scope of the embodiments.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

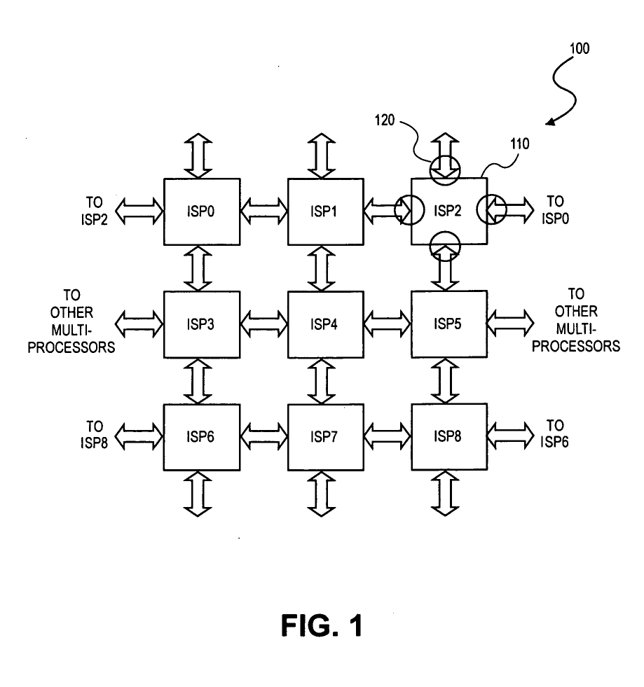

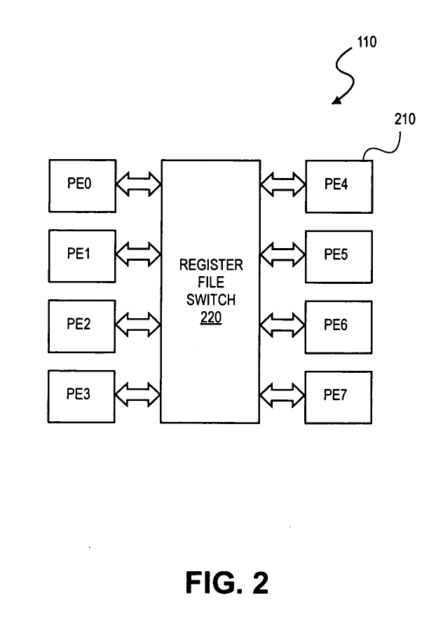

The embodiments discussed below are directed to debugging in a multiprocessing environment. In one embodiment, embedded debug functions assist developers with product implementation and validation. In one embodiment, the debugging environment is embedded in a multiprocessor as illustrated in FIG. 1. The debugging environment will first be introduced. FIG. 1 illustrates processing chip 100 designed to implement complex image processing algorithms using one or more image signal processors (ISP) 110 connected together in a mesh configuration using quad-ports 120. The quad-ports can be configured (statically) to connect various ISP's to other ISP's or to double data rate (DDR) memory using direct memory access (DMA) channels. FIG. 1 shows nine (9) ISP's 110 connected together with quad-ports 120. It should be noted that configurations with more or less ISPs 110 does not alter the scope of the embodiments to be discussed. ISP's 110 comprise several processor elements (PEs) 210 (illustrated in FIG. 2) coupled together with register file switch 220 (illustrated in FIG. 2). An ISP 110 in one multiprocessor can connect to an ISP in another multiprocessor via expansion interfaces, therefore increasing the number of ISPs coupled to one another.

FIG. 2 illustrates register file switch 220 that provides a fast and efficient interconnect mechanism. In achieving high performance, individual threads are mapped to PE's 210 in a way as to minimize communication overhead. The programming model dISP's 110 is such that each PE 210 implements a part of an algorithm and data flows from one PE 210 to another and from one ISP 110 to another until the algorithm is completely processed.

Disposed within each ISP 110 are PEs 210 as follows: an input PE (IPE), an output PE (OPE), one or more MACPEs and one or more general purpose PE (GPE). Also, included disposed within each ISP 110 is a memory command handler (MCH), etc. Data enters an ISP 110 through an IPE. The GPE's and other special purpose PEs process the incoming data. The data is sent out to a next ISP 110 by an OPE.

PE 210 uses a data driven mechanism to process data. In this data driven method, each piece of data in the system has a set of data valid (DV) bits that indicate for which PE 210 the data is intended for. Thus, if a register data is intended for two specific PE's 210 (e.g., PE0 and PE1), then the DV bit 0 and 1 of the register is set. If PE0 no longer needs the data, then it resets the DV bit 0. When the DV bits of all the consumer PE's in a register are reset, the producer PE can go ahead and write new data into the register with a new set having a DV bit setting. Otherwise, producer PE is stalled until the consumer PE's have reset their respective DV bits. Similarly, if a PE attempts to read a piece of data from a register and if its DV bit is not set, the PE stalls until there is data with a DV bit corresponding to the consumer PE set. This mechanism provides a very powerful method to share and use registers and significantly simplifies the user-programming model.

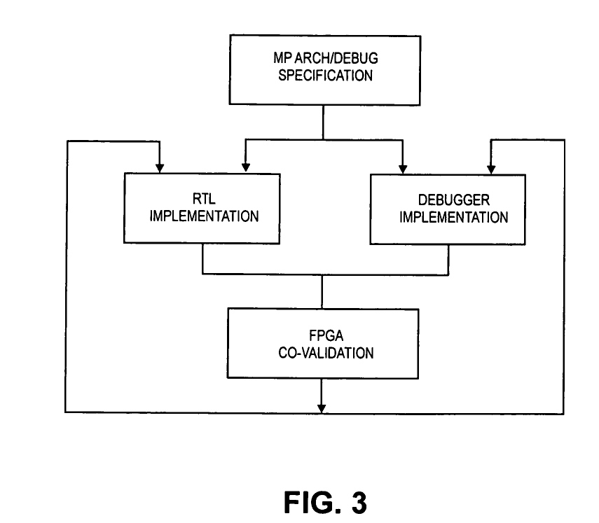

FIG. 3 illustrates a co-development environment for which an embodiment of embedded debugging is used. Multiprocessor 100 is developed by enabling development of a register transfer level (RTL) using a Very High Speed Integrated Circuit (VHSIC) hardware description language (HDL) [VHDL] and real-time hardware debugging environment concurrently. The RTL is developed in a phased manner using an embodiment of a real-time debugging process, which is developed along side the RTL to enable validation of the debugging environment, and also validation of the RTL.

The co-development and co-validation of the RTL and embodiment of a debugger process enables: validation of multi-processor RTL in a field programmable gate array (FPGA) environment, and development and validation of debugger processing code very early in the design phase, and very early firmware development as well. In one embodiment to support these features a debugging process embedded in a multiprocessor system includes phase/cycle accurate breakpoint and single-stepping capability, unlimited hardware break points capability, controllability and visibility into architecture state of all PEs 210.

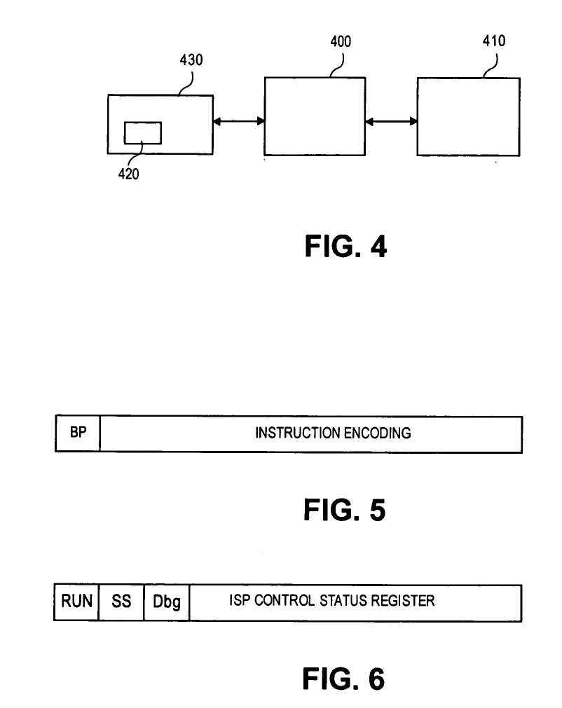

FIG. 4 illustrates an embodiment including an apparatus having processing chip 400 coupled controller 430 and to memory 410, such as a RAM, static RAM (SRAM), dynamic RAM (DRAM), synchronous DRAM (SDRAM), read-only memory (ROM), etc. In one embodiment debug process 420 is initiated by controller 430. In one embodiment debug process 420 attaches at least one breakpoint bit field to each instruction of a set of instructions within a PE, such as PE 210. In one embodiment debug process attaches at least three register bit fields (run/stop, single-step, and debug enable fields) to at least one control status register within an ISP, such as ISP 110. Memory 410 can store instructions loaded into a PE 210. Processing chip 400 is coupled to memory 410 and controller 430 by a bus, such as an internal bus, a network (such as a local area network (LAN) or wide area network (WAN)), etc.

FIG. 5 illustrates an instruction with an added bit field, which is added by debug process 420. In one embodiment the added bit field attached to each of the instructions is a breakpoint bit. The breakpoint bit allows a multiprocessor system having at least one processing chip 100 to enable unlimited breakpoint capability. In one embodiment if the breakpoint bit is set, a breakpoint is enabled for the particular instruction.

FIG. 6 illustrates a control status register attached with at least three additional bit fields. In one embodiment the at least three register bit fields comprise a run/stop field, a single step field and a debug enable field. In this embodiment if the run field bit is set, a set of instructions are allowed to continuously run. If the run field is not set, then a set of instructions are stopped. The run/stop feature enables a user to run or stop execution of ISPs 110. In one embodiment each ISP 110 is individually controlled using a run bit. When the run bit is set execution is continued. When the run bit is reset, the execution pipeline is stopped.

In one embodiment debug process 420 allows access to processing chip 100's architectural state. The ability to have visibility into all of the architecture state is important for assembly/source level debugging. In one embodiment this feature is implemented using a separate debug instruction register and an enable debug bit. In one embodiment debug process 420 can set or view any register by writing one of two instructions into the desired register and executing. In one embodiment the two instructions that can be executed in debug enabled mode are Load to Instruction RAM (LDTI) and Load from Instruction RAM (LDFI).

In one embodiment the LDTI instruction loads contents of a register into instruction RAM. Debug process 420 can then access instruction RAM to determine the register content. In one embodiment all instruction RAMs are accessible from the registers mapped to bus area. In one embodiment, the registers are mapped to a peripheral component interconnect (PCI) space. In this embodiment, the PCI space is accessible via a PCI port, joint test action group (JTAG) port, etc.

In one embodiment the LDFI instruction loads contents of an instruction RAM location into a specified register. This allows debug process 420 to write to any register by first writing the content to be written to the register into instruction RAM, followed by execution of an LDFI instruction.

In one embodiment the breakpoint enable bit enables a user to set a breakpoint based on an address of an instruction. In one embodiment the breakpoint feature is implemented using one (1) additional bit (BP bit) field added to an instruction and placed in the instruction RAM. The BP bit can be set or cleared by debug process 420. In one embodiment an instruction fetch unit (not shown) freezes the instruction pipeline upon encountering an instruction with its BP bit set to enable. With this embodiment, the breakpoint feature removes the necessity to perform address comparison (required in prior art schemes) and also allows a user to specify virtually unlimited number of break points through debug process 420.

In one embodiment an added single step bit field to the control status register allows a user to single-step through each line of code that is being debugged. The single step feature is implemented by advancing the instruction pipeline by a single cycle and then stopping the pipeline

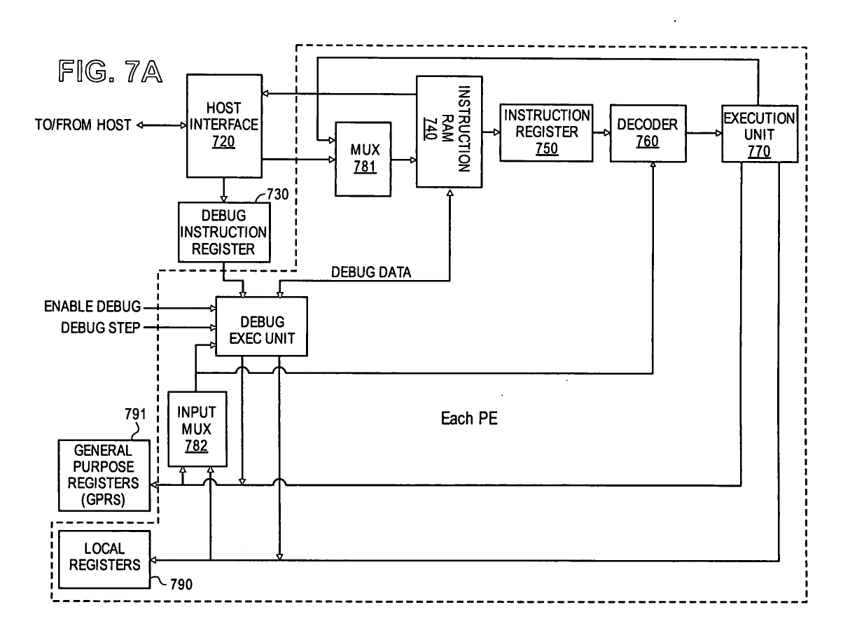

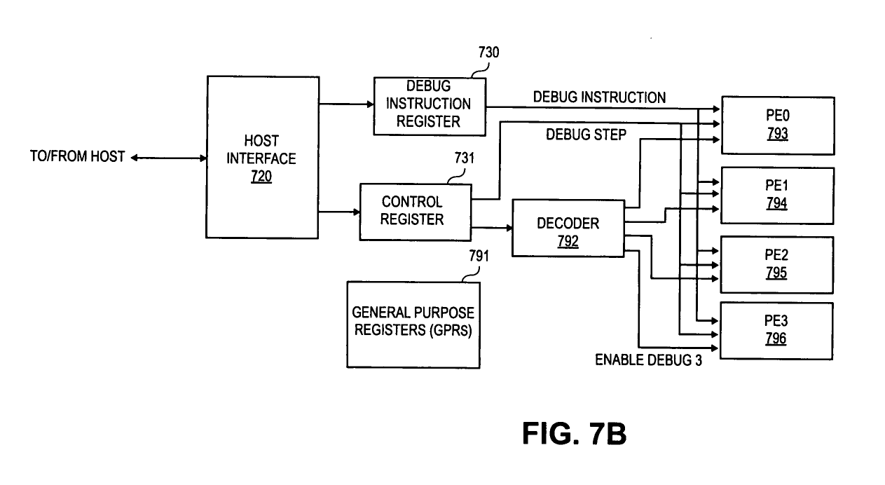

FIG. 7A illustrates a system adaptable to use debug process 420 to perform debug functions in an instruction pipeline. In FIG. 7A the dashed line indicates system 700. System 700 can be coupled with one or more host processors 710, host interface 720, debug instruction register 730, and a plurality of general purpose registers 791. System 700 includes instruction memory 740, instruction register 750, decoder 760, execution unit 770, debug executive unit 780 coupled to debug instruction register 730 and decoder 760, debug executive unit 781 coupled to instruction memory 740, second mux element 782 coupled to execution unit 770, and a plurality of local registers 790. The host processor includes debug process 420 for communicating and debugging system 700. In one embodiment debug process 700 attaches at least one bit field to each instruction transmitted to system 700, and attaches at least three register bit fields to a control status register. System 700 is repeated for each PE within an ISP.

Debug process 420 running in host processor 710 enables a user to set breakpoints, enable debugging, single step through cycles, run/stop, view the architectural states, and change or overwrite architectural states through a graphical user interface (GUI) displayed on a monitor and entered through a user interface (UI) (e.g., a keyboard, pointing device, etc.).

FIG. 7B illustrates debug hardware components for system 700. As illustrated in FIG. 7B, control register 731 is coupled decoder 792, PE0 (793), PE1 (794), PE2 (795) and PE3 (796).

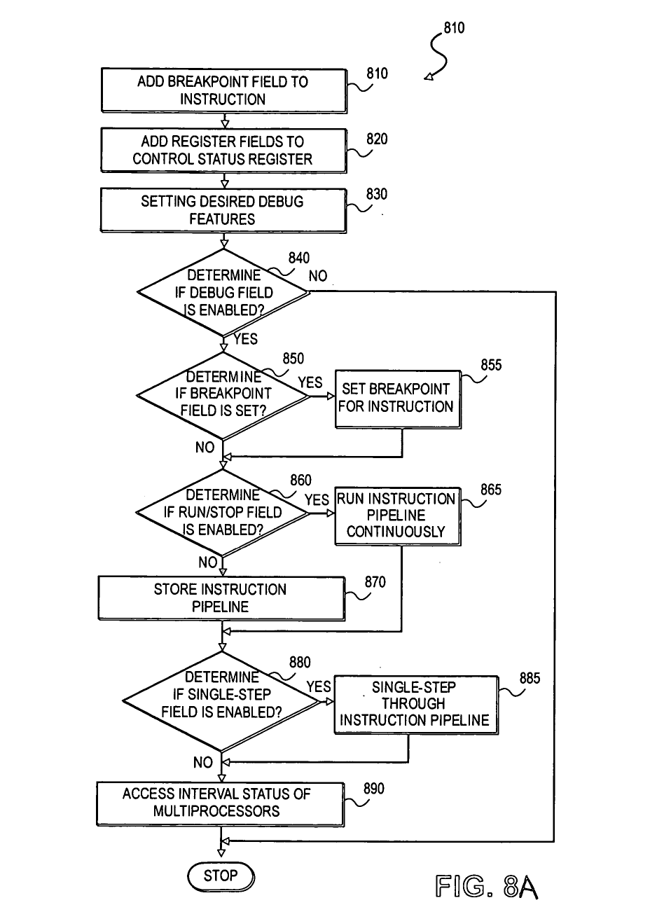

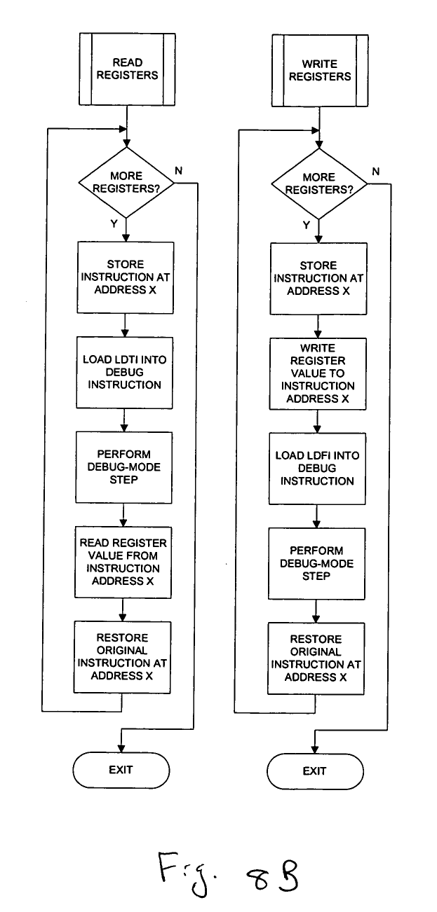

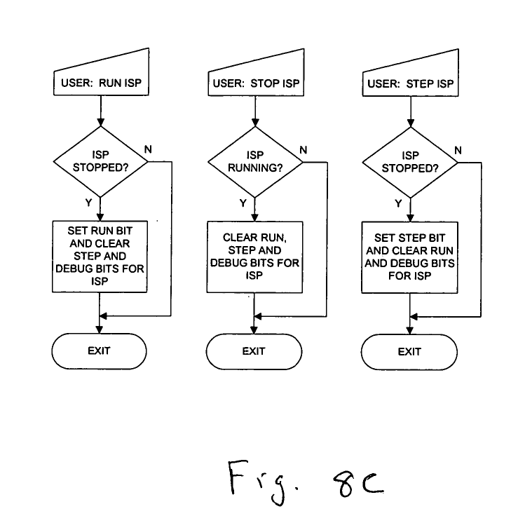

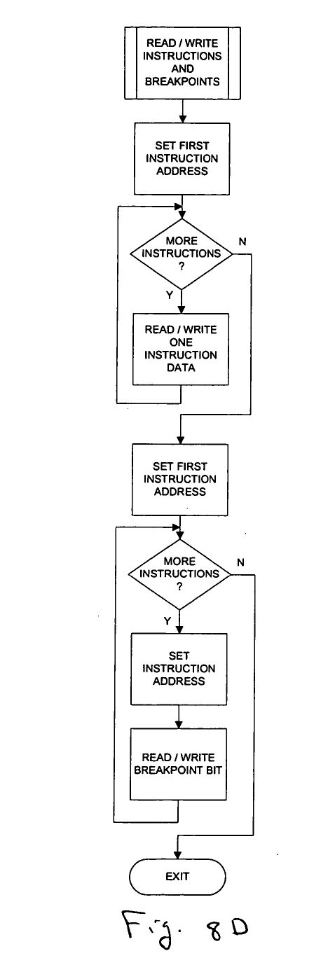

FIG. 8A illustrates a process for debugging a multi-microprocessor architecture environment. Process 800 begins with block 810. In one embodiment block 810 attaches an additional bit field to every instruction in a multi-processing architecture environment. The additional bit field added is one bit in length. The additional bit field added to all the instructions is used for setting breakpoints for the particular instructions address. If the additional bit field is enabled (e.g., set to one (1)), a breakpoint will occur for the particular instruction.

After block 810 is complete process 800 continues with block 820. In one embodiment three fields are attached to a control status register. The three attached fields are each one bit in length. In one embodiment, the first bit field added to the control status register is a run/stop enable field; the second bit field added to the control status register is a single-step enable field; and the third bit field added to the control status register is a debug enable field.

Process 800 continues with block 830 where desired debug settings are entered through a GUI and user interface. Block 840 determines whether the debug field in the control status register is set. If it is determined that the debug field is set, debug processing is enabled for the instruction pipeline. If it is determined that the debug enable field is not set, then debug processing is not allowed to process.

Block 850 determines whether the breakpoint bit is set for an instruction. If block 850 determines that the breakpoint bit is set, then block 855 sets a breakpoint for the particular instruction. If block 850 determines that the breakpoint field is not set, then process 800 continues with block 860. In one embodiment, to set a breakpoint bit, a user stops an ISP running process 800, selects a PE 210 within the ISP, and selects an instruction address to set the breakpoint. The instruction address is then written to memory and then a write is performed to set the breakpoint bit in the selected instruction.

Block 860 determines whether the run/stop field is enabled. If it is determined that the run/stop field is enabled, processing for the instruction pipeline runs continuously. If it is determined that the run/stop field is not set, the instruction pipeline is stopped at block 870. In one embodiment a user selects a specific ISP to run and the run bit is set in the control status register for that particular ISP.

Block 880 determines whether the single-step field is enabled. If block 880 determines that the single-step field is enabled, the instruction pipeline processes for a single cycle (block 885) and stops until a user enters a command to run another cycle through a GUI or user interface. In one embodiment a user selects an ISP to single-step through. The single-step bit is then set in the control status register for the particular ISP.

Block 890 accesses internal states of a multiprocessor system. The internal states are accessed by loading content of a register into an instruction memory and loading content of the instruction memory into the register. In this manner all internal states can be read out (e.g., to a GUI on a monitor) and written to or overwritten (through a GUI and/or user interface) for changing internal states manually. In one embodiment to read a register a user stops the particular ISP running process 800 and selects a PE in the ISP. The user selects a register to read from. Instruction memory at location X is stored to another location. A debug instruction register with a LDTI command and debug bit being set causes the register content to be stored to location X. The register content is read from location X and is displayed on a GUI. The stored instruction is then restored to location X.

In one embodiment to write to a register, a user stops the particular ISP running process 800 and selects a PE within the ISP. The user selects a register to write a new value to. An instruction content at location X is stored to another location. The new content of the register is stored to location X. A debug instruction register is used with a LDFI command and debug bit being set to transfer the new register content to the register from location X. The moved instruction is then replaced back at location X.

FIG. 8B illustrates the process of reading and writing registers. FIG. 8C illustrates the process of setting/clearing the run bit field, the single-step bit field and debug bit field. FIG. 8D illustrates the process of setting breakpoints for instructions and reading/writing the breakpoint bit field, and reading/writing instructions.

Process 800 continues while the debug enable bit is set. Otherwise, debug processing is halted. In one embodiment, after a particular ISP is run, the state of the ISPs are polled to determine whether any PEs stopped due to a breakpoint being set. After an ISP is stopped, a GUI displays updated instruction memory including breakpoints and updated register contents including a program counter. A user can then determine which breakpoint caused the ISP to stop.

In one embodiment debug process 420 provides advantages over prior art debuggers because the controllability and visibility of the register is provided using a debug execution pipeline that implements only two (2) instructions. The debug pipeline reuses a majority of normal execution pipeline logic to implement the debug functionality. The speed of debug process 420 is faster as compared to scan-based debugging approaches. For example, assume that user is interested in visibility to one register (e.g., LR0) in an ISP. If the scan chain has 2000 flip-flops in the path and a scan clock speed of 10 MHz., then a scan based debug approach would need 2000 clocks or 200 μS to update LR0. As compared to this, debug process 420 only requires less than 10 clocks ˜-<1 μs).

Additional advantages is ease of implementation and simplicity. That is, only a single bit is necessary to carry out a single-step through code. Also, only a single bit is necessary to implement breakpoints. As the breakpoint field is added to each instruction, no additional instructions are necessary in the instruction pipeline. This avoids additional latency that would occur due to additional instructions. Moreover, breakpoint instructions for adding and deleting breakpoints is avoided. The addition of debug fields to the control status register and instructions allows for system development to proceed in parallel with debugging. Prior art systems would typically require a system to be developed initially, then a debugging process to be generated afterwards.

The above debug process embodiments can also be stored on a device or machine-readable medium and be read by a machine to perform instructions. The machine-readable medium includes any mechanism that provides (i.e., stores and/or transmits) information in a form readable by a machine (e.g., a computer). For example, a machine-readable medium includes read-only memory (ROM); random-access memory (RAM); magnetic disk storage media; optical storage media; flash memory devices; biological electrical, mechanical systems; electrical, optical, acoustical or other form of propagated signals (e.g., carrier waves, infrared signals, digital signals, etc.). The device or machine-readable medium may include a micro-electromechanical system (MEMS), nanotechnology devices, organic, holographic, solid-state memory device and/or a rotating magnetic or optical disk. The device or machine-readable medium may be distributed when partitions of instructions have been separated into different machines, such as across an interconnection of computers.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. An apparatus comprising:
a plurality of processors coupled to a controller and a memory;
the controller to execute a debug process, said debug process attaches at least one breakpoint bit field to each of a plurality of instructions.

2. The apparatus of claim 1, wherein said breakpoint bit allows a breakpoint to be one of set and not set for each of said plurality of instructions.

3. The apparatus of claim 2, wherein a breakpoint bit set for an instruction is associated with the address of the instruction.

4. The apparatus of claim 1, and said controller attaches at least three debug register bit fields to at least one control status register, wherein said at least three register bit fields comprise a run field, a single step field and a debug enable field.

5. The apparatus of claim 4, said single step field allows a set of instructions to each be single-stepped through one cycle at a time.

6. The apparatus of claim 4, said debug enable field one of enables and disables a debug mode.

7. The apparatus of claim 1, wherein at least one instruction loads content of at least one register into an instruction memory coupled to said at least one processor via a bus.

8. The apparatus of claim 7, wherein content of said instruction memory is loaded into a register coupled to said at least one processor.

9. The apparatus of claim 1, wherein internal states of each of said plurality of processors are accessible through said debug process.

10. A system comprising:
a plurality of image signal processors (ISPs), each ISP including a plurality of processor elements (PEs), the plurality of ISPs including:
a debug instruction register coupled to a first mux element,
an instruction memory coupled to an instruction register,
a decoder coupled to said instruction register,
an execution unit coupled to said decoder,
a debug executive unit coupled to said instruction memory, and
a second mux element coupled to said execution unit and a plurality of local registers,
wherein the decoder to decode at least one breakpoint bit field of each of a plurality of instructions.

11. The system of claim 10, wherein said plurality of ISPs arranged in a matrix pattern and each having quad-ports.

12. The system of claim 11, said plurality of PEs each coupled to a register file switch.

13. The system of claim 10, the decoder to decode at least three debug register bit fields of a control status register, wherein said at least three register bit fields comprise a run field, a single step field and a debug enable field.

14. The system of claim 13, said single step field allows a set of instructions to each be single stepped through one instruction at a time.

15. The system of claim 10, wherein at least one instruction loads content of said debug instruction register into said instruction memory.

16. The system of claim 15, wherein content of said instruction memory is loaded into said debug instruction register.

17. The system of claim 16, wherein internal states of said plurality of PEs are accessible through said debug instruction register.

18. An apparatus comprising a machine-readable medium containing instructions which, when executed by a machine, cause the machine to perform operations comprising:
attaching at least one breakpoint bit field to each of a plurality of instructions,
attaching at least three debug register bit fields to at least one control status register.

19. The apparatus of claim 18, further containing instructions which, when executed by a machine, cause the machine to perform operations including:
determining a state of said breakpoint bit, and
setting a breakpoint for an instruction if it is determined that said state of said breakpoint bit is set.

20. The apparatus of claim 18, wherein said at least three register bit fields comprise a run field, a single step field and a debug enable field.

21. The apparatus of claim 20, further containing instructions which, when executed by a machine, cause the machine to perform operations including:
determining a state of a run field bit, and
running a set of instructions if said state of said run field bit is set, and
stopping a set of instructions if said state of said run field bit is not set.

22. The apparatus of claim 21, further containing instructions which, when executed by a machine, cause the machine to perform operations including:
determining a state of a single step bit,
single-stepping through a set of instructions for a cycle if said state of said single-step bit is set.

23. The apparatus of claim 18, further containing instructions which, when executed by a machine, cause the machine to perform operations including:
loading content of at least one register into an instruction memory,
loading content of said instruction memory into the at least one register, and
accessing internal states of each of a plurality of processors through said debug process.

24. A method comprising:
attaching at least one breakpoint bit field to each of a plurality of instructions,
attaching at least three breakpoint register bit fields to at least one control status register,
wherein the attached breakpoint bit field is an additional field added to each instruction.

25. The method of claim 24, further comprising determining a state of said breakpoint bit, and
setting a breakpoint for an instruction if it is determined that said state of said breakpoint bit is set.

26. The method of claim 24, further comprising:
running a debug process on a host device, and
entering debug commands through a graphical user interface.

27. The method of claim 24, wherein said at least three register bit fields comprise a run field, a single step field and a debug enable field.

28. The method of claim 24, further comprising:
determining a state of a single-step bit,
entering commands for single-stepping through a set of instructions for a cycle if said state of said single-step bit is set.

29. The method of claim 24, further comprising:
loading content of at least one register into an instruction memory,
loading content of said instruction memory into the at least one register, and
accessing internal states of each of a plurality of processors through said debug process, wherein accessing includes reading state values and overwriting state values.
